(19) United States
(12) Patent Application Publication
(10) Pub. No.: US 2017/0039654 A1
(43) Pub. Date: Feb. 9, 2017

(54) A computer implemented methodology executed by at least one processor that uses at least the names of individual Private Funds to automatically analyze portfolios of private investments and to create benchmarks.

(71) Applicant: Peter MCGRATH, Toronto (CA)

(72) Inventor: Peter McGrath, Toronto (CA)

(21) Appl. No.: 15/303,499

(22) PCT Filed: Nov. 21, 2014
(86) PCT No.: PCT/IB2014/066242

§ 371 Date: Oct. 11, 2016

(30) Foreign Application Priority Data
May 8, 2014 (IB) PCT/IB2014/001225
Jun. 27, 2014 (IB) PCT/IB2014/062690

(51) Int. Cl. G06Q 40/06; G06F 17/30

(52) U.S. Cl. CPC G06Q 40/06; G06F 17/3053; G06Q 50/18

(57) ABSTRACT

This methodology is developed to help users thoroughly analyze private investment portfolios that requires minimal information from the user, as little as the Private Fund names in the portfolio of private investments by extrapolating information about the funds as a whole. The methodology automatically analyzes a Portfolio's composition across many Private Fund characteristics; generates benchmarks for a specific type of investor; compares investor's Portfolio to a benchmark; formulate investment recommendations; estimates the secondary market price of the Portfolio; determines the leveragability of the Portfolio; and generates divestment ideas. The main steps involved in the methodology including: construction of databases for investment information, investor information, benchmarks, and lenders information. Collating investment information and investor information, so that for a given investor there is a list of their Portfolio holdings along with investment information and stored in a collated information database. All databases are updated regularly. A specially designed program will perform above analyses using information from databases and minimal data from users and generate a report that may include one or multiple analyses aforementioned.

### BACKGROUND OF INVENTION

“Private Fund”, as used herein and throughout this description, refers to closed ended private fund investments and private direct equity and private debt investments in private companies, real estate and other investments that may be a part of an institutional investor's portfolio that are subject to substantial restrictions on transferability and are not publically traded. Examples of a private fund include but are not limited to private equity, private closed ended funds of funds, buyout, venture capital, real estate, natural resources, and energy funds that are not openly marketed to the general public and are generally subject to substantial restrictions on transferability. A Private Fund, in its singular form, refers to a single Private Fund, or a group of related Private Funds that have the same strategy and are managed by the same manager.

“Portfolio”, as used herein and throughout this description, refers to a portfolio of Private Funds.

The present invention is related to a methodology that automatically generates Portfolio analysis which requires as little as the names of individual Private Funds, from users and contains components of Portfolio analysis, benchmark creation, comparison of investor's Portfolio to benchmarks, offering buy, sell or investment recommendations, secondary market Portfolio price estimation, estimation of the leveragability of the Portfolio, and generation of divestment ideas for private investments by extrapolating information from Private Funds as a whole. The disclosure relates to details and steps used in the methodology that analyze a Portfolio's exposure to different Private Fund Traits; establish benchmarks based on holdings of various selected groups of investors; suggest investment ideas based on a comparison of a portfolio of Private Funds with a benchmark chosen by the user; estimate the secondary market price of a Portfolio of Private Funds based on the price of each Private Fund, current market conditions, buyer preferences and investor's holdings; determine whether a Portfolio qualifies for leverage based on specific tests, estimate how much leverage a specific Portfolio is qualified for based on the portfolios characteristics, lenders' lending specifications and current market conditions, and generate divestment ideas based on analyses of the Portfolio's characteristics.

By its nature, the private investments industry lacks transparency on information. Typically, Investors only source of information regarding a specific Private Fund is the general manager of that Private Fund, and most of the time, general partners only provide related data to limited partners in the Private Fund. Moreover, typical investors prefer to keep their Portfolio holdings confidential, making it difficult to generate comparative analyses of a Portfolio relative to others. In addition, investors are often neither aware of the current market value or the salability of their Portfolio nor their liquidity options, should the need for liquidity arise. The methodology allows a user to provide minimal information about a Portfolio to generate an analysis based on a wealth of investor and third party generated information resources. At a minimum, the name of the Portfolio (for reference purpose only) and the names of the Portfolio's individual Private Fund holdings are necessary for the method to produce insightful analyses.

The methodology presented resolves the following issues present at the industry as a result of lack of transparency of the information related to Private Funds: (a) lack of methods to analyze a Portfolio as there is little readily available information on Private Funds in comparison to public securities, for instance, mutual fund's performance data is available on major finance websites but such information for Private Funds are generally not available in the public domain; (b) lack of benchmarking on investor Portfolio's exposure to different fund traits due to the fact that not only is there limited information available on Private Funds, but also on individual investor's Portfolio holdings which is required to create aggregate benchmarks.

The methodology is based on the information collected on an ongoing basis from numerous sources including social media. The method allows investors to confide Portfolio information through forms and electronic communication to a system of databases and a specially designed program. A Portfolio is analyzed based on its distributions across various Private Fund traits and compared with selected benchmark to formulate customized recommendations. Portfolios used to construct the investor type benchmarks are based on the type of institutional investor and a collection of partial or complete Portfolios from that specific type of investor whereas the all investors benchmark is based on all the Private Funds raised historically that have not been liquidated. Updates to the set of known portfolios and the related Private Funds make the benchmark portfolios and derived estimates continually dynamic. Further, the methodology utilizes the information gathered to predict a specific Portfolio's price in the secondary market. The methodology also determines if a Portfolio qualifies for leverage and estimates the amount of leverage and terms, from different lenders, a specific Portfolio may qualify for. Based on the investment holdings provided by users and relevant information in the databases, the methodology automatically generates possible divestment ideas. The methodology can automatically generate a report based on one or multiple components of the aforementioned, using the specially designed program, i.e., Component 1—SI Portfolio Analysis; Component 2—Benchmark Creation; Component 3—SI Portfolio and Benchmark Portfolio Comparison; Component 4—Investment Recommendations; Component 5—Secondary Market Portfolio Price Estimation; Component 6—Leveragability of the Portfolio; Component 7—Generation of Divestment Ideas. The methodology provides access to these analyses and renders reports to users in print form or electronically using a single computer or via the internet or local network, databases and programs.

### BRIEF SUMMARY OF THE INVENTION

“Private Fund”, as used herein and throughout this description, refers to closed ended Private Fund investments and private direct equity and private debt investments in private companies, real estate, infrastructure, timberland, and other investments that may be a part of an institutional investor's portfolio that are subject to substantial restrictions on transferability and are not publically traded. Examples of a Private Fund include but are not limited to private equity, private closed ended funds of funds, buyout, venture capital, real estate, natural resources, and energy funds that are not openly marketed to the general public and are generally subject to substantial restrictions on transferability. A Private Fund, in its singular form, refers to a single Private Fund, or a group of related Private Funds that have the same strategy and are managed by the same manager.

“Portfolio”, as used herein and throughout this description, refers to a portfolio of Private Funds.

“Portfolio Holding” or “Portfolio Holdings”, as used herein and throughout this description, refers to a single Private Fund investment or multiple Private Fund investments within a Portfolio.

The invention described in this method allows users to provide minimal information to a computer implemented methodology that automatically generates analyses on Portfolios, that includes, one or a combination of, the following components: analysis of a Portfolio's exposure to different Private Fund traits; benchmarks created based on investment information gathered from various sources; comparison of a Portfolio to a selected benchmark, investment recommendations based on the comparison; prediction of the Portfolio's price on the secondary market, which is very intransparent and undeveloped relative to the public stock market; determination of whether a Portfolio will qualify for leverage; estimation of the amount of leverage a specific Portfolio might qualify for; and divestment ideas generated for the specific Portfolio.

The methodology necessitates the creation of a “Private Fund Database”, a “SI Portfolio Database”, a “Collated Information Database”, a “Benchmark Database” and a “Lenders Database.” The Private Fund Database contains information on the characteristics of all known Private Funds; SI Portfolio Database contains the name of each Portfolio and its Portfolio Holdings and may contain information on the sizes of each Portfolio Holding; Collated Information Database contains investors' information, each investor's Portfolio Holdings, and the size of each of their Portfolio Holdings and the holdings' Private Fund traits; Benchmark Database contains the benchmark portfolios for certain investor types or investor groups and Lenders Database has information on the terms of financing for leverage providers and information on adjustment factors. The methodology uses the data to conduct portfolio analyses, generate benchmarks and formulate buy, sell or invest recommendations based on comparisons with the appropriate benchmark.

Equipped with data on prevailing secondary market prices for Private Funds, the methodology models the secondary market price of a portfolio. Information on the lending criteria of lenders allows the system to determine the likely terms of borrowing using Private Funds as collateral, enabling investors to automatically gain insight into the levels and terms of leverage their portfolio may qualify for without having to inquire directly with each or any lender. The method further generates divestment ideas based on Private Fund's characteristics.

### BRIEF DESCRIPTION OF FIGURES

FIG. 1 shows simplified view of initial set up required for the methodology

FIG. 2 shows a flowchart of the methodology

FIG. 3 shows a flowchart of the construction of a specific investor portfolio

FIG. 4: shows a flowchart of the collating information process

FIG. 5 shows an example of the output chart summarizing the analysis of fund characteristics, where data range percentages for 4 Data Ranges of the Private Fund Trait (type of Private Fund) are calculated

FIG. 6 shows an example of the output chart summarizing the analysis of fund characteristics, where data range totals, and data range percentages for Private Fund Type (using net asset value as the IEM) are calculated

FIG. 7 shows a flowchart for the creation of a benchmark portfolio

FIG. 8 shows an example of the output chart summarizing the analysis of benchmarks, where we calculated the benchmark data range percentages for 4 Data Ranges for the Private Fund Trait (type of Private Fund) of a Benchmark Portfolio

FIG. 9 shows an example of the output table summarizing the analysis of benchmarks, where Benchmark Data Ranges, benchmark data range totals, and benchmark data range percentages for Private Fund Type using net asset value as the benchmark investor exposure measurement for Benchmark Portfolio are calculated

FIG. 10 shows an example of output chart summarizing the analysis of a comparison of benchmark portfolio and a specific investor's portfolio

FIG. 11 shows an example of output table summarizing the analysis of a comparison of benchmark portfolio and a specific investor's portfolio, where data range totals, data range percentages for a specific investor portfolio (ABC Co. Pension's), the corresponding benchmark weighted data range totals, benchmark data range percentages, and the differentials for the given data ranges are calculated

FIG. 12 shows an example of the output table summarizing the Secondary Market Portfolio Price Estimation

FIG. 13 shows an example of the table summarizing the loan to value ratio of Private Fund AAA.

FIG. 14 shows an example of the output table summarizing the loan amount calculation for a leverage test Portfolio (XYZ) that contains Private Fund AAA, BBB, and CCC

FIG. 15 shows an example of the output table summarizing the alternative method for loan amount calculation, where weighted average loan to value ratio is calculated

FIG. 16 shows an example of the output table summarizing the alternative method for loan amount calculation

### DETAILED DESCRIPTION OF THE INVENTION

The claims and disclosure herein provide a new method that utilizes a specially designed program to facilitate a methodology that allows users to provide minimal information, as little as private investments' name, to extrapolate information about the private investments as a whole, to automatically generate an analysis of a portfolio of private investments across various traits of private investments, that includes, one or a combination of, the following components: analysis of the portfolio's exposure to different private investment traits; benchmarks created based on investment information gathered from various sources; comparison of a specific portfolio of private investments to a selected benchmark and investment recommendations based on the comparison; prediction of the private investment portfolio's price in the secondary market; estimation of the amount of leverage a specific portfolio of private investment might qualify for; and divestment ideas generated for the specific portfolio of private investments. The methodology further produces an electronic or printed report that includes one or a multiple of the components aforementioned, as per user's selection.

The following terms and definitions are used throughout the detailed description:

“Private Fund”, as used herein and throughout this description, refers to closed ended private fund investments and private direct equity and private debt investments in private companies, real estate, infrastructure, timberland and other investments that may be a part of an institutional investor's portfolio that are subject to substantial restrictions on transferability and are not publically traded. Examples of a Private Fund include but are not limited to private equity, private closed ended funds of funds, buyout, venture capital, real estate, natural resources, and energy funds that are not openly marketed to the general public and are generally subject to substantial restrictions on transferability. A Private Fund, in its singular form, refers to a single Private Fund, or a group of related Private Funds that have the same strategy and are managed by the same manager.

“Private Fund Name”, as used herein and throughout this description, refers to a Private Fund's name and its alternative names and aliases.

“Portfolio”, as used herein and throughout this description, refers to a portfolio of Private Funds.

“Portfolio Holding”, as used herein and throughout this description, refers to a Private Fund within a Portfolio.

“User”, as used herein and throughout this description, refers to the person who uses the system described herein.

“Interface”, as used herein and throughout this description, refers to a platform that is used by Users to construct the Portfolios and display analyses and reports.

“NAV”, as used herein and throughout this description, refers to net asset value.

“Commitment”, as used herein and throughout this description, refers to a total amount of money that an investor is obligated to contribute over a period of time to a Private Fund under a contractual agreement.

“Private Fund Size”, as used herein and throughout this description, refers to the sum of Commitments made by all investors in a Private Fund. An investor of a Private Fund owns a slice of the Private Fund and the percentage of ownership equals an investor's Commitment divided by the Private Fund Size. All capital calls and distributions are typically allocated to all investors on a pro-rata basis based on their percentage of ownership.

“Funded Commitment”, as used herein and throughout this description refers to the amount of money an investor has contributed to a Private Fund.

“Unfunded Commitment”, as used herein and throughout this description, in the singular form, refers to the difference between an investor's Commitment and Funded Commitment; in its plural form, refers to the difference between a Private Fund's size and it Funded Commitments.

“Cumulative Distribution”, as used herein and throughout this description, in its singular term, refers to a total amount of cash and stock that has been paid out to one limited partner; in its plural term, refers to a total amount of cash and stock that has been paid out to all limited partners.

“Specific Investor's Portfolio” or “SI Portfolio”, as used herein and throughout this description, refers to the portfolio of Private Funds generated by the User using the Interface.

“Unique Private Fund ID”, as used herein and throughout this description, refers to a unique identifying number assigned to a Private Fund by a specially designed program. A Private Fund may be only entered once in the database, however, a Private Fund may have several Private Fund Names, and all these Private Fund Names are associated to the same Unique Private Fund ID. For example, Bain Asia I, Bain Capital Asia I, and Bain Capital Asia Fund I are associated to the same Unique Private Fund ID.

“Investor Exposure Measurement” or “IEM”, as used herein and throughout this description, refers to a measurement unit of an investor's exposure to a Private Fund. Examples of investor's exposure measurement include net asset value, commitment, unfunded, drawn, net asset value plus unfunded, and number of funds.

“Private Fund Trait”, as used herein and throughout this description, refers to characteristics of a Private Fund, including Private Fund name, Private Fund manager, Private Fund geographic focus, Private Fund industry focus, Private Fund strategy, Private Fund investment stage, Private Fund fundraising status, Private Fund Size (as used herein refers to amount committed by all investors), country of Private Fund head office, target Private Fund size, currency of the Private Fund, Funded Commitments (as used herein refers to amount invested by all investors), Unfunded Commitments (as used herein refers to amount committed by all investors but not yet paid in), NAV (net asset value), Cumulative Distributions (as used herein refers to a total amount of cash and stock that has been paid to all limited partners by the Private Fund), NAV to commitment ratio (Private Fund NAV divided by Private Fund size), TVPI also known as Total Value to Paid In (as used herein refers to the ratio calculated by dividing a sum of Cumulative Distributions and NAV from Funded Commitments), RVPI (as used herein refers to the ratio calculated by dividing NAV from Funded Commitments), DPI (as used herein refers to the ratio calculated by dividing Cumulative Distributions from Funded Commitments), Unfunded Ratio (as used herein refers to the ratio calculated by dividing Unfunded Commitments from Private Fund Size), IRR (internal rate of return), performance quartile and decile rank, Setter Liquidity Rating, price and price range of the Private Fund in the secondary market, loan to value ratios for the Private Fund from aggressive lenders, moderate lenders, and conservative lenders.

“Investor Trait”, as used herein and throughout this description, refers to characteristics of a specific investor. Examples of investor traits include investor's name, investor's asset under management, location, type of investor, etc.

“Portfolio Holding Size”, as used herein and throughout this description, refers to the investor's Commitment, Funded Commitment, Unfunded Commitment, NAV, or Cumulative Distribution.

“Private Fund Ratios”, as used herein and throughout this description, refers to one or multiple of following ratios: NAV to commitment ratio (Private Fund NAV divided by Private Fund size), TVPI also known as Total Value to Paid In (as used herein refers to the ratio calculated by dividing a sum of Cumulative Distributions and NAV from Funded Commitments), RVPI (as used herein refers to the ratio calculated by dividing NAV from Funded Commitments), DPI (as used herein refers to the ratio calculated by dividing Cumulative Distributions from Funded Commitments), Unfunded Ratio (as used herein refers to the ratio calculated by dividing Unfunded Commitments from Private Fund Size).

“Data Range”, as used herein and throughout this description, refers to pre-set intervals in the specially designed program for each Fund Trait needed to analyze the Portfolio's exposure to different Fund Traits. For example, Data Ranges for Private Fund types include leverage buyout funds, venture capital funds, debt, infrastructure funds, fund of funds, secondary funds, real asset funds, energy funds, real estate funds, and other.

### The Hardware Embodiment

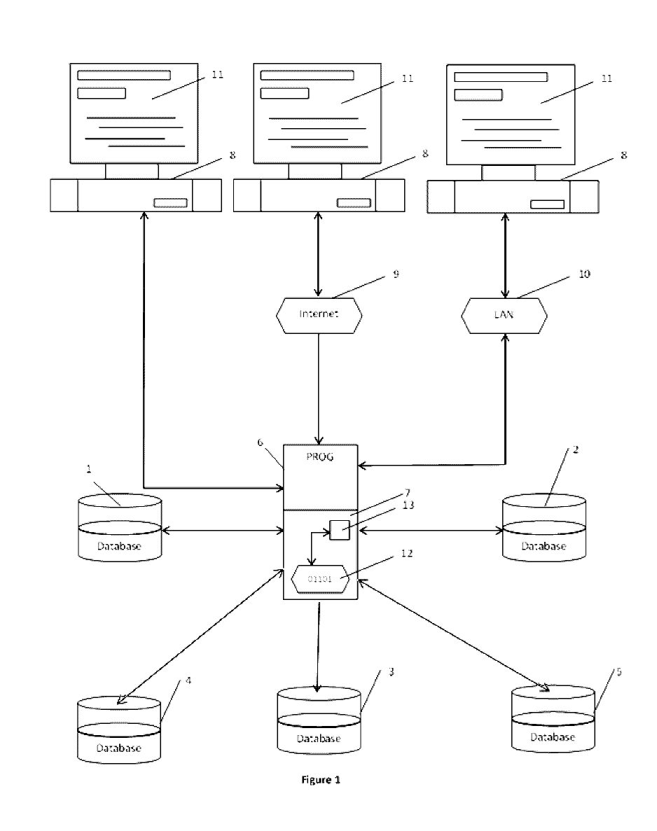

The hardware embodiment required and its functionality is shown in FIG. 1. The system comprises the Collated Information Database (1), Private Fund Database (2), SI Portfolio Database (3), Benchmark Database (4), and Lenders Database (5) connected to a server (6) which contains a computer-readable medium (7), connected directly to a terminal or computer (8), to the internet (9), or a local area network (10), which in turn are connected either with wires or remotely to a user's terminal (8) which can transmit data and information entered to and from the Interface (11), the Interface can be accessed from any computer that is connected to the server directly, via the Internet or a local area network. A specially designed program (12) comprising computer readable statements and instruction, is stored in the computer readable medium (7), written in a language such as Java, Python, ASP.NET, Sal or any other computer programming language capable, when run by a processor (13), of facilitating real time communication and sharing of files stored in databases and performing portfolio analyses. The databases (1, 2, 3, 4, and 5) are updated from time to time by storing new data, accessing updated data using direct connection, local area network connections or internet connection. This methodology can be performed simultaneously by multiple Users through one or multiple connections.

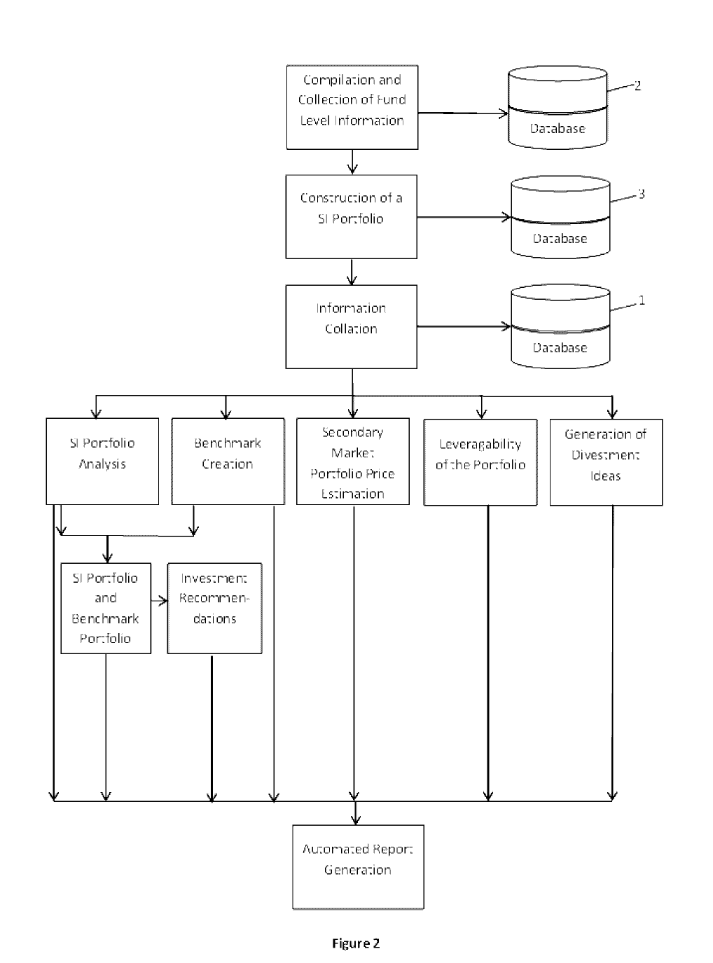

The functionality of the system is shown in FIG. 2. First, all fund level information is collected and stored in the Private Fund Database (2). The User enters required and optional SI Portfolio information; the information is stored in SI Portfolio Database (3). The specially designed program (12) (not shown) will collate the data from Private Fund Database (2) and SI Portfolio Database (3), creating the Collated Information Database (1). The specially designed program (12) will create and update benchmark portfolios—benchmark information is stored in Benchmark Database (4) (not shown). The specially designed program will perform comparative analyses of the SI portfolio to the respective benchmark portfolio. The specially designed program (12) will generate investment recommendations based on deviations of the SI portfolio from the selected benchmark. The specially designed program (12) will generate price estimates for the SI Portfolio. Using information from the Lenders Database (5) (not shown), the program will perform an analysis of the leveragability of the Portfolio. The specially designed program (12) will also perform analyses to generate divestment ideas. A report with all or User-selected analyses is created in various format.

### Compilation and Collection of Private Fund Level Information

I. Compile and collect, on an ongoing basis, Private Fund Traits on all Private Funds that have been raised historically. Information is collected from various sources, for example, directly collected from institutional investors, managers of the funds or through data providers. Such information can be collected through various channels and mediums, such as phone and oral communications, emails and online platforms that include social media.

II. Each Private Fund will be assigned a Unique Private Fund ID by the specially designed program (12).

III. Private Fund Traits for each Private Fund are recorded in a database (“Private Fund Database”) (1). Information in the Private Fund Database is updated regularly.

### Construction of a SI Portfolio

I. For each Portfolio, Investor Traits, Portfolio Holdings and Portfolio Holding Sizes are collected by the User through various sources and channels. For example, the investor can provide their Portfolio Holdings' information to the User through emails or a data forms. The investor can itself be the User as well, in which case, this step does not apply.

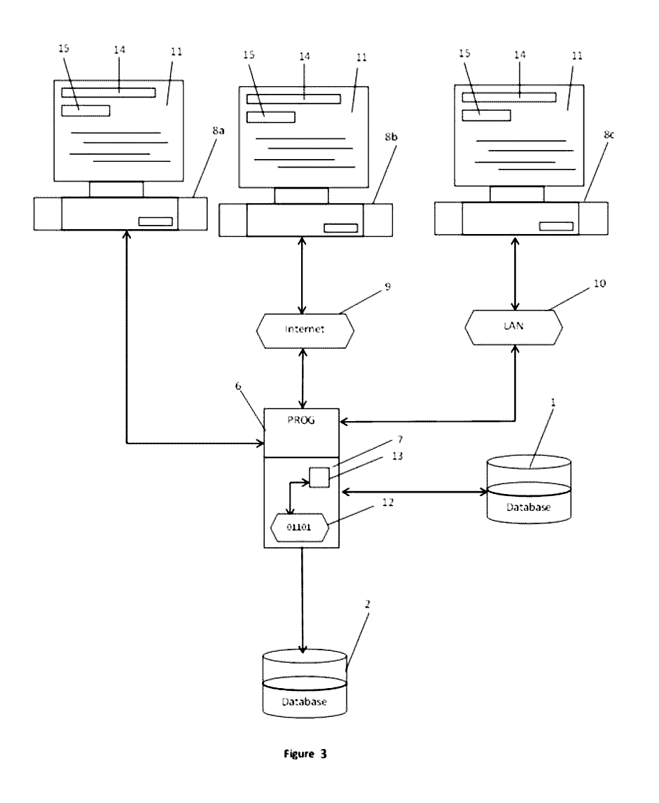

II. As shown in FIG. 3, Users can access the Interface from any terminal or computer (8) that is connected to the Server (6), the local area network (10) which in turn is connected to the Server, or the internet (8) which in turn is connected to the Server.

III. Investor Traits, including but not limited to, investor's name, type of investor, asset under management (AUM), and location are entered through the Interface (11). The minimum information required from the User is the Portfolio's name (which usually is investor's name for an actual existing Portfolio, but may be arbitrary as well) and names of each of their Portfolio Holdings. The User enters the name for the Portfolio (required) in the name field (14) and other Investor Traits (Optional) in the Interface (11).

IV. The User selects the IEM in the Interface. Examples of IEMs include commitment, NAV, unfunded, NAV plus unfunded, and number of funds.

V. The User enters part or all of a Private Fund Name (“Search String”) in the Interface Screener (15). The Interface Screener on the terminal or computer (8) that is directly connected to the server (6), the local area network (10) or the internet (9) which in turn connect to the server (6) that contains a specifically designed program (12) which, when run by a processor (13), searches the Search String in the Private Fund Database (1) and returns Private Funds whose names contain the Search String, along with their Unique Private Fund ID and other Private Fund Traits of that Private Fund (e.g. Vintage Year, Private Fund size, Private Fund manager, Private Fund type, etc.), which will be displayed in the search result.

VI. The User selects the correct Private Fund he was looking for and the Unique Private Fund ID will be added to his SI Portfolio and stored in the SI Portfolio Database (2).

VII. After the User selects the Private Fund, the Interface will ask the User to enter Portfolio Holding Sizes. If the User selected an IEM of number of funds they may skip this step, otherwise they must enter at least one of the Portfolio Holding Sizes (e.g., Commitment, Funded Commitment, Unfunded Commitment, investor's NAV, or Cumulative Distributions) for each Private Fund selected. Repeat Step V to VII as many times as needed until the User has constructed a SI Portfolio that contains all the Private Funds he wants to include.

### Information Collation

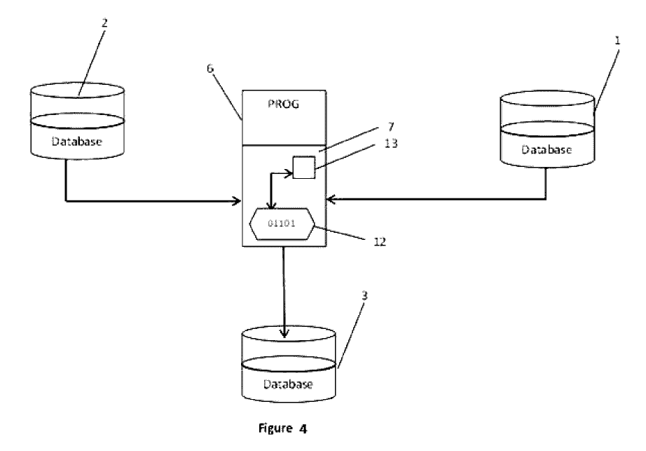

I. As shown in FIG. 4, the specially designed program (12), when run by a processor (13) will collate data from the SI Portfolio Database (2) with the information in the Private Fund Database (1) for Private Funds with the same Unique Private Fund ID to make a “Collated Record” so that for a given investor there is a list of their Portfolio Holdings and Portfolio Holding Sizes (if the User has entered any) along with Private Fund Traits of each Private Fund. For example, if the User has entered commitments for the portfolio, the collated record of a Private Fund would include, the Private Fund Name, the investor's commitment to this Private Fund, and Private Fund information, such as Fund Size, Funded Commitments, Unfunded Commitment, NAV of the Private Fund.

II. The specially designed program (12) will record all Collated Records in a database (“Collated Information Database”) (3).

III. The specially designed program (12) updates information in the Collated Information Database (3) every time there is an update in the Private Fund Database (1) or SI Portfolio Database (2).

### SI Portfolio Analysis

I. The specially designed program (12) will extract User's selection of Investor Exposure Measurement (IEM) from the SI Portfolio Database.

II. Calculate the total of the IEM for a SI Portfolio to determine the IEM Total. Examples of IEM Totals are “Total Investor NAV” (the sum of all investor's NAVs of the Private Funds in a given SI Portfolio); “Total Investor Unfunded” (the sum of all Unfunded of the Private Funds in a given SI Portfolio); “Total Investor NAV Plus Unfunded” (the sum of the Total Investor NAV and Total Investor Unfunded for a given SI Portfolio); “Total Investor Commitments” (the sum of all Commitment of the Private Funds in a given SI Portfolio); “Total Investor Number of Private Funds” (the number of Private Funds in a given SI Portfolio).

III. Calculate the sum of the IEM of the Private Funds whose Private Fund Trait falls within each preset Data Range (the sum is herein referred to as the “Data Range Total” or “DRT”) (e.g. if IEM is set as NAV and Private Fund types is the Fund Trait being analyzed, then the Data Range Total for leverage buyout Private Funds equals the total NAV of leverage buyout Private Funds the investor owns).

IV. Determine the data range percentages (“Data Range Percentages” or “DR%”) by dividing the DRT by the IEM Total. For example, divide the total NAV of LBO Private Funds by the Total Investor NAV of the given SI Portfolio to determine the DR% for that specific Data Range (leverage buyout Private Funds).

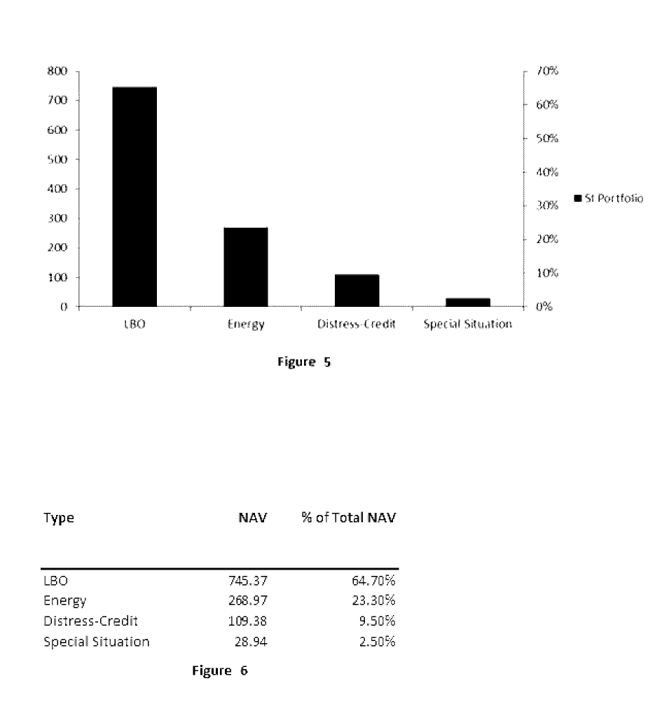

V. The specially designed program (12) can create charts and tables that show the DR%s and the DRTs for each Data Range across various Private Fund Traits (See Automated Report Generation). FIG. 5 and FIG. 6 are examples of output charts and tables of SI Portfolio Analysis.

### Benchmark Creation

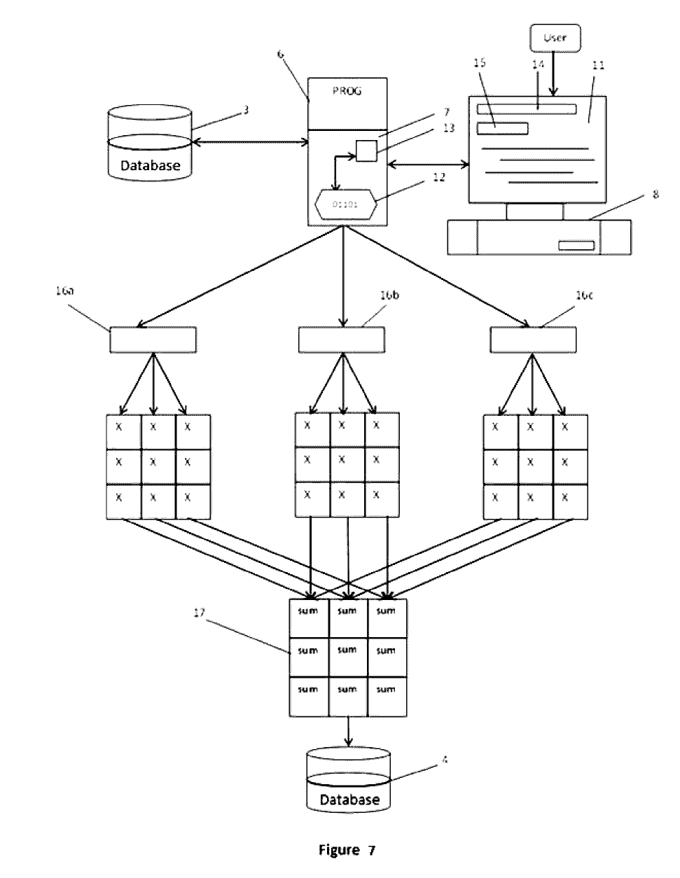

I. As shown in FIG. 7, via the Interface (11), the User will select the specific type of investor and one or multiple types of Private Funds, such as private equity, real estate, infrastructure, and real asset, the User would like to use as a benchmark. For example, a User may choose the type of investor being “US Public Pensions with asset under management greater than 1 billion” owning Private Fund types of “private equity and real estate”. For each benchmark, the Portfolios used to construct these benchmarks are pre-determined in the specially designed program. The specially designed program (12) will search in the Collated Information Database (3) and find all Collated Records (16a, 16b, 16c) in the pre-determined Portfolios that match the selected type of investor and types of Private Funds selected by the User and aggregate all these Collated Records to create the Benchmark Portfolio (17) and store this information in a database (“Benchmark Database”) (4). For example, continuing from the example above, the specially designed program will aggregate all Collated Records whose type of investor is “US Public Pensions with asset under management greater than 1 billion” and whose type of Private Fund is “private equity and real estate” to create the Benchmark Portfolio). The User also has the option to choose the “All Investors Benchmark”, which by definition indicates the Benchmark Portfolio would include all investors' Portfolios investing in certain or all Private Fund types. Alternatively, since the aggregation of all investors' Portfolios represents all the Private Funds raised in the market, the Benchmark Portfolio for All Investors is based on the summation of all Private Funds of the types chosen in the Private Fund Database.

II. The specially designed program (12) calculates the total of the chosen IEM (“Benchmark IEM Total” or “BIEM Total”) for the Benchmark Portfolio. Examples of BIEM Totals are “Total Benchmark NAV” (the sum of all investor's NAV of the Private Funds in the Benchmark Portfolio); “Total Benchmark Unfunded” (the sum of all Unfunded of the Private Funds in the Benchmark Portfolio); “Total Benchmark NAV Plus Unfunded” (the sum of the Total Benchmark NAV and Total Benchmark Unfunded for the Benchmark Portfolio); “Total Benchmark Commitment” (the sum of all Commitment of the Private Funds in the Benchmark Portfolio); “Total Benchmark Number of Private Funds” (the number of Private Funds in the Benchmark Portfolio). Store this information in the Benchmark Database.

III. For each Fund Trait, the specially designed program (12) will calculate the sum of the IEM of Private Funds whose Private Fund Trait falls within each Data Range (the sum being the “Benchmark Data Range Total” or “BDRT”) and store this information in the Benchmark Database.

IV. Determine the Benchmark Portfolio's data range percentages (“Benchmark Data Range Percentage or “BDR%”) by dividing the Benchmark Data Range Total by the appropriate BIEM Total. For example, divide the total NAV of LBO Private Funds by the Total NAV of the given Benchmark Portfolio to determine the BDR% for that particular Data Range (LBO Private Funds).

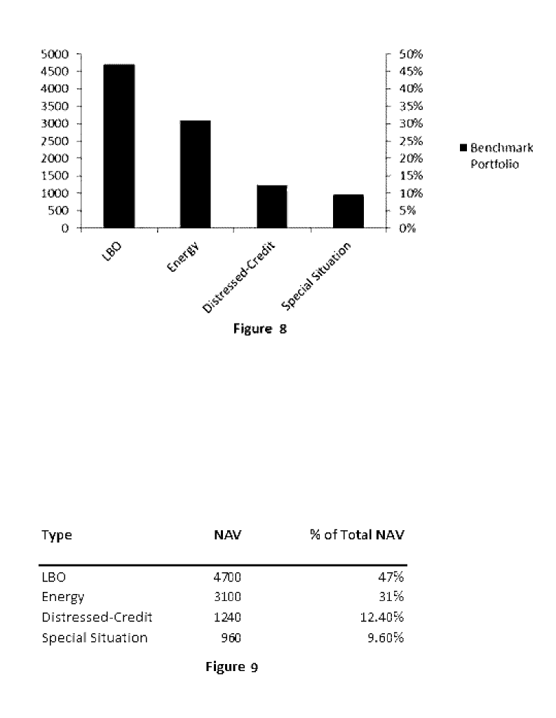

V. The specially designed program (12) will create charts and tables that show the BDR%s and the BDRTs for each Data Range across various Private Fund Traits (See Automated Report Generation). FIG. 8 and FIG. 9 are examples of output chart and tables of Benchmark Creation.

### SI Portfolio and Benchmark Portfolio Comparison

I. Calculate the “Benchmark Weighted Data Range Total” (“BWDRT”) of the IEM by using SI Portfolio's IEM Total multiplied by the BDR%. For example, if the fund Trait being analyzed is private equity Private Fund types, and IEM is selected as NAV, examples of the BWDRT would be “Target LBO NAV” (Total Investor NAV times Benchmark LBO Percentage); “Target Energy NAV” (Total Investor NAV times Benchmark Energy Percentage); “Target Distress-Credit NAV” (Total Investor NAV times Benchmark Distress-Credit Percentage); “Target Special Situation NAV” (Total Investor NAV times Benchmark Special Situation Percentage).

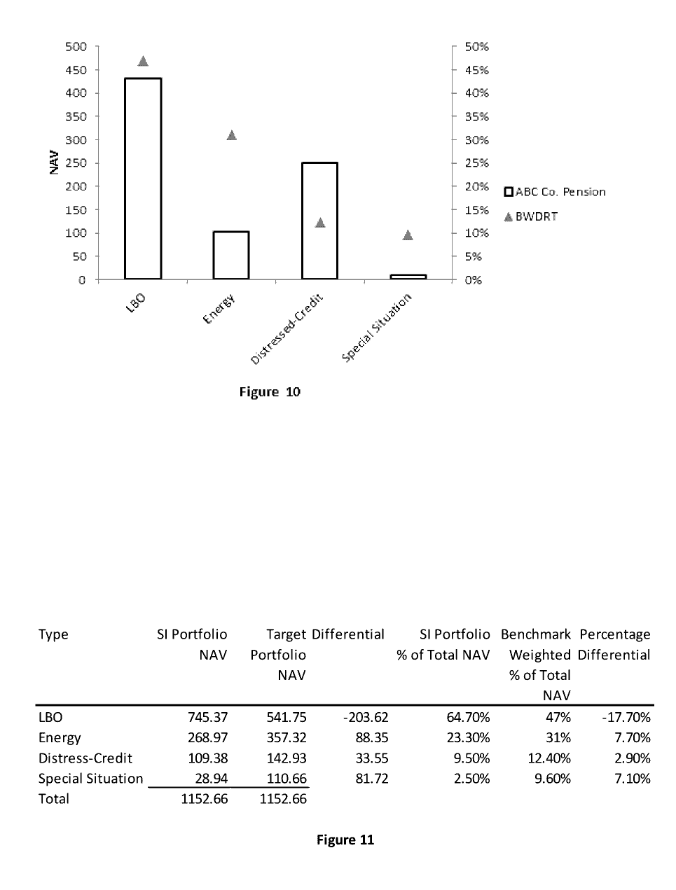

II. The specially designed program (12) can create charts and tables that show the differences in the DRTs and DR%s for a SI Portfolio and the corresponding BWDRTs and BDR% for the corresponding Data Ranges (See Automated Report Generation). FIG. 10 and FIG. 11 are examples of output chart and tables of SI Portfolio and Benchmark Portfolio Comparison.

### Investment Recommendations

The specially designed program (12) will make buy or invest recommendations based on a negative deviation of SI Portfolio's DRT to BWDRT. The specially designed program (12) will calculate the amount to buy or invest which is equal to the difference between the DRT and BWDRT and the percent to buy or invest which is equal to the difference between the DR% and BDR%. The recommendations are relevant to an investor that is trying to achieve the BWDRT and the BDR%.

The specially designed program (12) will make a sell recommendation based on a positive deviation of SI Portfolio's DRT to BWDRT. The specially designed program (12) will calculate the amount to sell which is equal to the difference between the DRT and BWDRT and the percent to sell which is equal to the difference between the DR% and BDR%. The recommendations are relevant to an investor that is trying to achieve the BWDRT and the BDR%. The specially designed program (12) will create a summary of the buy, sell and invest Recommendations (See Automated Report Generation).

### Secondary Market Portfolio Price Estimation

The specially designed program (12) will extract the secondary pricing data from the Collated Information Database for each Private Fund in the SI Portfolio and calculate the price (in both actual dollar figure and percentage of NAV) using below formulas. All of which can be summarized as a report (See Automated Report Generation)

(Dollar Price) Size Adj.×(Private Fund Price₁×Private Fund NAV₁+Private Fund Price₂×Private Fund NAV₂+ . . . +Private Fund Priceₙ×Private Fund NAVₙ)

(Percentage of NAV Price) [Size Adj.×(Private Fund Price₁×Private Fund NAV₁+Private Fund Price₂×Private Fund NAV₂+ . . . +Private Fund Priceₙ×Private Fund NAV)]/Total NAV

Where,

Size Adj.=the adjustment factor (a percentage) to the SI Portfolio due to the size of the portfolio. This factor takes into consideration market conditions, buyer preferences and other relevant considerations. For example, a larger portfolio will have a high Size Adj. due to the size premium given by secondary buyers and the higher possibility of qualifying for leverage.

Private Fund Price =the secondary market price of a specific Private Fund (expressed as a percentage of NAV)

Total NAV=the total NAV of the Portfolio

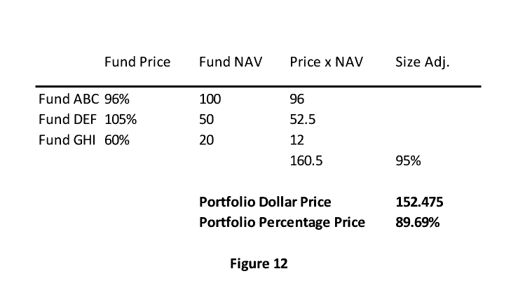

The specially designed program (12) will create a summary of Secondary Market Portfolio Price Estimation (See Automated Report Generation). FIG. 12 shows an example of the output table of Secondary Market Portfolio Price Estimation.

### Leveragability of the Portfolio

All information gathered from the lenders, the examples of lenders' information include lenders' names, lenders' types, and their interest rates and other fees charged, is stored in the Lenders Database. This database is updated from time to time.

In order to conduct leverage tests, Users must select Private Funds and enter at least one of the following for every Private Fund being considered for collateral in the Interface: NAV, drawn, unfunded, or commitments. These selected Private Funds will be constructed as a Leverage Test Portfolio (“LT Portfolio”). The specially designed program (12) will run tests including but not limited to below Leverage Test on the LT Portfolio. Predetermined thresholds (“Reference Value”) for each test are determined based on the current market conditions and lenders' requirements, which may change at any time. These Reference Values are also stored in the Lenders Database. The specially designed program (12) will calculate and suggest the likely cost of debt and the amount of debt the LT Portfolio qualifies for, all of which can be summarized as a report (See Automated Report Generation).

I. Leverage Tests
a. Size Test:
   i. Calculate Total NAV for the LT Portfolio (“LT NAV”).
   ii. The LT Portfolio will only pass the test if the LT NAV is greater than the Reference Value (e.g. $75 million).
   iii. Size Test is also a binary test. If the LT Portfolio fails this test, it will not qualify for leverage from any of the lenders, regardless of their type (Aggressive, Moderate and Conservative).
b. Liquidity Test:
   i. Calculate total NAV for Private Funds that have a Setter Liquidity Rating (“Rated NAV”), and calculate total NAV that don't have Setter Liquidity Rating (“Unrated NAV”)
   ii. Calculate the percentage of Rated NAV to LT NAV.
   iii. The portfolio will only pass the test if Rated NAV divided by LT NAV is greater than a Reference Value (e.g. 75%).
c. Private Funded Level Test:
   i. Calculate the portfolio's total drawn, total unfunded and total commitment.
   ii. Calculate the percentage of total drawn to total commitment.
   iii. The portfolio will only pass this test if the percentage is greater than a reference value (e.g. 30%).
d. Portfolio Diversification Test:
   i. Calculate the total NAV for a certain number (e.g. 3) of the biggest Private Funds.
   ii. Calculate the percentage of total NAV of the certain number (e.g. 3) of the Biggest Private Funds to the LT NAV.

iii. The portfolio will only pass the test if this percentage is less than a Reference Value (e.g. 60%).
e. Developed Markets Test:
   i. Calculate the Total NAV of USA/Canada, Western European, Global, and Australian focused Private Funds (“Developed Markets NAV”).
   ii. Calculate the percentage of Developed Markets NAV to LT NAV.
   iii. The portfolio will only pass the test if this percentage is greater than a Reference Value (e.g. 70%).
f. Old NAV test:
   i. Calculate the total NAV of Private Funds before a specified year (e.g. 2005) (“Old NAV”).
   ii. Calculate the percentage of Old NAV to LT NAV.
   iii. The portfolio only passes the test if this percentage is less than a Reference Value (e.g. 70%).
g. Favored Strategies Test:
   i. Calculate the total NAV of Private Funds whose type are favored by lenders (“Favored Strategies NAV”). The examples of favored Private Fund type include LBO & Mezzanine.
   ii. Calculate the percentage of Favored Strategies NAV to LT NAV.
   iii. The LT portfolio will only pass the test if this percentage is greater than a Reference Value (e.g. 70%).

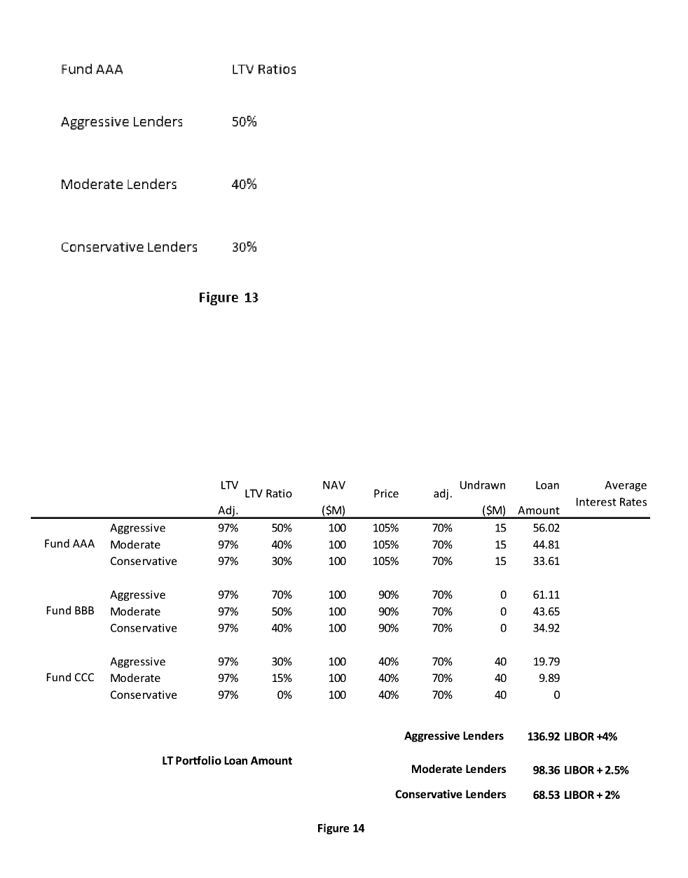

II. Loan Amount Calculation (Method A)
h. For each Private Fund, the specially designed program (12) will extract LTV ratios from the Collated Information Database for 3 types of lenders: aggressive lenders, moderate lenders, and conservative lenders. Therefore, every Private Fund will have 3 LTV ratios. FIG. 13 shows an example of a table summarizing loan to value ratios from lenders.
i. The specially designed program (12) will calculate the loan amount available to a specific Private Fund from each type of lender using the below formula:

LTV×(NAV×Price+Adj.×Undrawn)×LTVAdj
Where,
LTV=loan to value ratio
Adj.=the adjustment factor (a percentage) to Undrawn, this factor is derived based on market conditions, and other relevant considerations. This factor is 70% for current market conditions.
LTVAdj=Adjustment factor (a percentage) to the portfolio's loan to value ratio, it accounts for the size of the portfolio and risk factors related to certain portfolio concentration.
j. The loan amount qualified for a specific LT Portfolio is the sum of loan amounts qualified for each Private Fund in that portfolio.
k. The specially designed program (12) calculates the average interest rates charged by each type of lender from the Lenders Database. FIG. 14 shows an example of the output table summarizing the loan amount calculation for a portfolio.

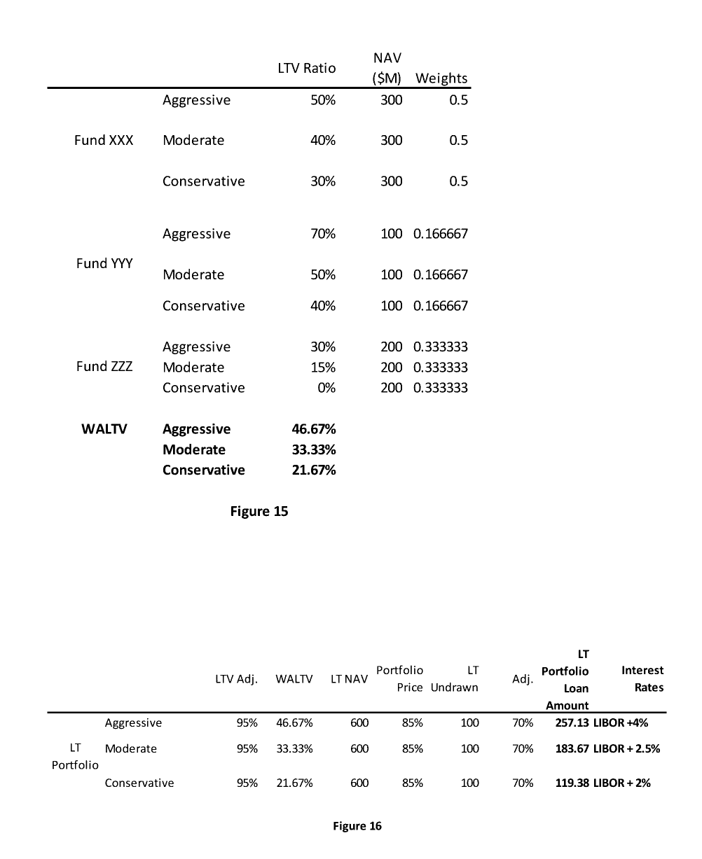

III. Loan Amount Calculation (Method B)
a. The specially designed program (12) can calculate the loan amount available to a LT Portfolio based on the price of the entire portfolio. The specially designed program (12) will calculate the weighted average of the LTV ratios (“WALTV”) for each type of lender based on a weighting of each Private Fund's NAV. FIG. 15 shows an example of the output table summarizing the calculation of the WALTV.
b. A specially designed program (12) will then calculate the loan amount available to the entire portfolio based on the below formula:

LTVAdj×WALTV×(LT NAV×Portfolio Price+LT Undrawn×Adj.)
Where,
WALTV=weighted average loan to value ratios
LT NAV=Total NAV of the LT Portfolio (can be calculated by aggregating the NAV of each portfolio holding in a LT Portfolio)
Portfolio Price=the secondary market price for the entire portfolio (this price can be derived from Secondary Market Portfolio Price Estimation section or entered in by the User)
LT Undrawn=the sum of all unfunded for the entire LT Portfolio
Adj.=the adjustment factor (a percentage) to the entire Portfolio' total Undrawn, this factor is derived based on market conditions, and other relevant considerations. This factor is 70% for current market conditions. For a given LT portfolio, Adj. is the same for each Portfolio Holdings.
LTVAdj=Adjustment factor (a percentage) to the portfolio LTV accounts for the size of the portfolio and risk factors related to certain portfolio concentration.
c. The specially designed program (12) gathers the average interest rates charged by each type of lender from the Lenders. FIG. 16 shows an example of the output table summarizing the calculation of the loan amount calculation. The specially designed program (12) will create a summary of the leveragability of the portfolio (See Automated Report Generation).

### Generation of Divestment Ideas

The specially designed program will perform the below tests to a SI Portfolio and identify Private Funds to possibly sell (“Sale Candidate Private Fund”). All predetermined values (“Reference Value”) are determined based on current market conditions and other relevant considerations for below tests. All of which can be summarized as a report (See Automated Report Generation)

I. Concentration Test
a. Calculate the percentage of the IEM of each Private Fund to the IEM Total (“Individual Private Fund IEM Percentage”).
b. The specially designed program (12) will identify Private Funds as Sale Candidate Private Funds if their Individual Private Fund IEM Percentage is greater than a Reference Value (e.g. 10%), as the investor may have too much concentration in this Private Fund.

II. Growth Potential Test
a. If the TVPI for a Private Fund is very high there may be less growth potential in this Private Fund than Private Funds with lower TVPIs.
b. The specially designed program (12) will identify Private Funds as Sale Candidate Private Funds if their TVPIs are greater than a Reference Value.

III. Manager Termination Test
a. For every “Private Fund Family” (A group of Private Funds follow the same strategy and managed by the same manager), calculate the number of years between the vintage year of its latest Private Fund and the current year (“Year Gap”).
b. The specially designed program (12) will identify Private Funds as Sale Candidate Private Funds if they are part of a Private Fund Family where the Year Gap is greater than a Reference Value (e.g. 6 years), because this Private Fund Family will most likely not be raising more Private Funds and will be inactive in the future.

IV. Unfunded Test
a. Calculate the Percentage of the Unfunded of a specific Private Fund to the total Unfunded of the portfolio.
b. The specially designed program (12) will identify Private Funds as Sale Candidate Private Funds if this percentage is greater than the Reference Value which is expressed as a percentage of total Unfunded (e.g. 15%), as the investor may have too much unfunded exposure to this Private Fund.

V. Legacy Relationship Test
a. For every Private Fund Family, the program will check if the investor owns the latest Private Fund in the Private Fund Family.
b. The specially designed program (12) will identify Private Funds as Sale Candidate Private Funds if the investor hasn't committed to the latest Private Fund of the Private Fund Family, because, most likely, the investor no longer favors this manager.

VI. Past Maturity Private Fund Test
The specially designed program (12) will identify Private Funds as Sale Candidate Private Funds if the gap between current year and the vintage year of a specific Private Fund is more than a Reference Value (e.g. 10 years) because the Private Fund likely has limited upside potential and is of negligible value.

VII. Negligible Value Test
The specially designed program (12) will identify Private Funds as Sale Candidate Private Funds if the Private Fund's NAV plus unfunded is less than a minimal Reference Value, suggesting the Private Fund is too small to warrant the costs associated with monitoring the investment.

VIII. Highest Priced Private Funds Test
The specially designed program (12) will identify the Private Funds with the highest secondary pricing as Sale Candidate Private Funds, as these would create the most liquidity for an investor at the least discount to NAV.

### Automated Report Generation

The specially designed program (12) used in the preceding steps can output the corresponding analysis and results in the form of a report that includes various Components:

I. Component 1—SI Portfolio Analysis—This Component can be generated after performing “SI Portfolio Analysis”. The specially designed program (12) will create charts and tables that show the DR%s and the DRTs for each Data Range across various Private Fund Traits.

II. Component 2—Benchmark Creation—This Component can be generated after performing “Benchmark Creation”. The specially designed program (12) will create charts and tables that show the BDR%s and the BDRTs for each Data Range across various Private Fund Traits.

III. Component 3—SI Portfolio and Benchmark Comparison Analysis—This Component can be generated after performing “SI Portfolio Analysis”, “Benchmark creation”, “SI portfolio and Benchmark Portfolio Comparison”. The specially designed program (12) will create charts and tables that show the differences in the DRTs and DR%s for a SI Portfolio and the corresponding BWDRTs and BDR% for the corresponding Data Ranges.

IV. Component 4—Investment Recommendations—This Component can be generated after performing “SI Portfolio Analysis”, “Benchmark creation”, “SI portfolio and Benchmark Portfolio Comparison”, and “Investment Recommendations”. The specially designed program (12) will create a summary of buy or sell or invest recommendations based on comparing the SI Portfolio's Data Range Total to the Benchmark Weighted Data Range Total for each Private Fund Trait.

V. Component 5—Secondary Market Portfolio Price Estimation—This Component can be generated after performing “Secondary Market Portfolio Price Estimation”. The specially designed program (12) will create a report that summarizes the estimates.

VI. Component 6—Leveragability of the Portfolio—This Component can be generated after performing “Leveragability of the Portfolio”. The specially designed program (12) will create a report that summarizes the results of the Leverage Tests, the likely cost of debt and the amount of debt the LT Portfolio qualifies for.

VII. Component 7—Divestment Ideas—This Component can be generated after performing “Generation of Divestment Ideas”. The specially designed program (12) will create a report that summarizes the results of the Sale Candidate Tests.

Using the Interface, a User can select to include one or more Components in their report

One skilled in the art will appreciate that many variations are possible within the scope of the claims. Thus, while the disclosure is particularly shown and described above, it will be understood by those skilled in the art that these and other changes in form and details may be made therein without departing from the spirit and scope of the claims.

1. A method for analyzing private investment portfolios that requires minimal information from users, comprising steps of
creating databases of information;
analyzing the distribution of private investment portfolio in different fund characteristics;
creating benchmarks using a specially designed program;
comparing an investor's portfolio to a benchmark;
formulating investment recommendations using the specially designed program;
estimating the secondary price of the portfolio using the specially designed program;
estimating the amount of leverage a specific portfolio might qualify for using the specially designed program; and
generating divestment ideas using the specially designed program.

2. The method of claim 1 wherein the step of creating databases of information comprises steps of creating a database of institutional investor information, a database of collated information, a database of benchmark information, and a database of lender information.

3. The method of claim 2 wherein the step of analyzing the distribution of private investment portfolio in different fund characteristics comprises steps of
collating information from the fund database with the database of specific investors' portfolios to create a collated portfolio for a specific investor, and this information is store in the collated information database; and
producing an analysis of the weighting of the exposure of the collated portfolio across various investment characteristics.

4. The method of claim 1 wherein the step of creating benchmarks using a specially designed program comprises steps of
aggregating portfolios of institutions of the same type from the database of collated portfolios to create a benchmark portfolio and store this information in the benchmark database; and
calculating the percentage exposure of the benchmark portfolios across various Investment characteristics.

5. The method of claim 1 wherein the step of comparing an investor's portfolio to a benchmark
comparing the percentage exposure between an investor's collated portfolio created in claim 3 and a benchmark portfolio created in claim 4 across various investment characteristics; and
comparing the absolute amount of exposure between an investor's collated portfolio created in claim 3 and target exposures calculated as the benchmark weights multiplied by the investor's portfolio's total amount of exposure across various investment characteristics.

6. The method of claim 1 wherein the step of formulating investment recommendations using the specially designed program comprises steps of
recommending the investor to invest or buy more in a specific Investment trait in order to achieve the benchmark weighting when the investor's percentage exposure to a certain trait is below the benchmark weighting exposure by a certain percentage; recommending that the investor sells exposure in a specific Investment trait in order to achieve the benchmark weighting when the investor's percentage exposure to a certain trait is above the benchmark weighting exposure by a certain percentage; and
calculating the amount recommended, which equals to the differences between the investor portfolio's exposure to the benchmark's percentage exposure multiplied by the total investor portfolio's exposure;

7. The method of claim 1 wherein the step of estimating the secondary price of the portfolio using the specially designed program comprises the steps of
itemizing the top secondary price and secondary price ranges for each investment in a given portfolio by referencing the data from the database of private investments;
summing the secondary prices of each investment in the portfolio to estimate likely secondary price and range of secondary prices for the entire portfolio if sold in the secondary market;
adjusting the secondary price for the entire portfolio, up or down, based on relevant factors; and
dividing the dollar price figure to the total NAV of the entire portfolio to determine the price (percentage of NAV) for the portfolio.

8. The method of claim 1 wherein the step of estimating the amount of leverage a specific portfolio might qualify for using the specially designed program comprises the steps of
performing various tests to investor's portfolio;
calculating the loan amount available to each Investment from each type of lender based the quality and the pricing of the underlying portfolio,
adjusting the loan amount for individual holdings based on relevant factors. The examples of such factors include current market conditions, lenders' preferences, and other relevant considerations;
adjusting the loan amount for the entire portfolio based on relevant factors. The examples of such factors include the size of the portfolio, risk factors related to certain portfolio concentration;
summing the loan amounts available for each investment in the portfolio to arrive at the loan amounts available for the entire portfolio from each type of lender.

9. The method of claim 1 wherein the step of estimating the amount of leverage a specific portfolio might qualify for using the specially designed program comprises the steps of
performing tests to investor's portfolio. The examples of such tests include size test, liquidity test, funded level test, portfolio diversification test, developed markets test, old NAV test, and favored strategies test;
calculating the weighted average loan to value ratio for the entire portfolio;
calculating the loan amount based on the weighted average loan to value ratio, the quality of the underlying portfolio, and the pricing of the underlying portfolio; and
adjusting the loan amount for the entire portfolio based on relevant factors. The examples of such factors include the size of the portfolio, the funding status of the portfolio, risk factors related to certain portfolio concentration, and other relevant considerations.

10. The method of claim 1 wherein the step for generating divestment ideas using the specially designed program
applying various tests to investor's portfolio;
suggesting funds to possibly sell based on the results of the above tests.

11. The method of claim 1 further comprising the step of producing a report that summarizes the analysis, charts and tables from claims 1 to 9.

12. The method of claim 1 wherein producing a report that summarizes the analysis, chart and tables from claims 1 to 9 includes
presenting investor's portfolio exposure across different investment characteristics. The examples of investment characteristics include vintage year, geography focus, type of Funds, and Setter Liquidity Ratings;
presenting benchmark portfolio exposure across different investment characteristics. The examples of investment characteristics include vintage year, geography focus, investment strategies, and Setter Liquidity Ratings;
presenting investor's portfolio exposure across different investment characteristics. The examples of investment characteristics include vintage year, geography focus, secondary pricing, investment strategies, and Setter Liquidity Ratings along with Benchmark Portfolio's characteristics;
comparing investor's portfolio with a benchmark portfolio and make buy, sell or invest recommendations;
presenting estimated secondary pricing for individual investments and a portfolio;
presenting leverage test results and loan amounts available to a portfolio;
applying automatic identification of investments for sale tests to investor's portfolio and recommend investments for sale based on the result of these tests [symbol]
